(19) United States
(12) Patent Application Publication
(10) Pub. No.: US 2011/0046332 A1
(43) Pub. Date: Feb. 24, 2011

(54) HYDROGEL BASED ON COPOLYMERS CONTAINING SILICONE

(75) Inventors: Christine Maria Breiner, Laudenbach (DE); Marianne Omeis, Dorsten (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Evonik Roehm GmbH, Darmstadt (DE)

(21) Appl. No.: 12/936,486

(22) PCT Filed: Apr. 23, 2009
(86) PCT No.: PCT/EP09/54885

§ 371 Date: Oct. 5, 2010

(30) Foreign Application Priority Data
Jun. 12, 2008 (DE) 10 2008 002 375.2

(51) Int. Cl. C08F 226/06; C08F 230/08; C08F 224/00; C08F 226/10

(52) U.S. Cl. 526/264; 526/279; 526/270; 526/263

(57) ABSTRACT

The invention relates to a hydrogel which is a copolymer formed from a polymerizable monomer mixture which contains
a) 10-65 mol % of at least one hydrophobic vinyl monomer of the formula I

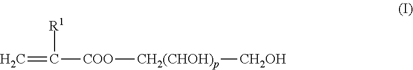

in which R¹ is hydrogen or methyl, p is an integer from 1 to 8, whose hydroxyl groups are present in protected form,
b) 25-70 mol % of at least one silicone-containing (meth)acrylate, vinyl carbonate or vinyl carbamate monomer,
c) 0-25 mol % of at least one hydrophilic vinyl monomer and
d) 0-10 mol % of at least one crosslinker, based on the total amount of monomers a) to c),
and where the hydroxyl groups of the segments formed by the monomers a) in the hydrogel are present in protected form or in free form. The hydrogel can be used to produce contact lenses or intraocular lenses.

The invention relates to novel hydrogels based on silicone-containing copolymers, to processes for preparation thereof and to use thereof as a contact lens material or intraocular lens material.

For some years, there has been a great demand for contact lenses made of a material with high oxygen permeability and good compatibility with the eye even in the case of prolonged wear.

It is known that hydrogels (crosslinked polymers of limited swellability in water) possess an oxygen permeability which depends on the water content. It increases with rising water content. It is additionally known that polymers which contain fluorinated units and those which are formed on the basis of polysiloxanes are notable for particularly high oxygen permeabilities. However, the water content of polymers which consist entirely or predominantly of the two latter substance groups is low. The fundamentally desired high oxygen permeability is normally achieved in the known polymers by accepting other serious disadvantages. For instance, hydrogels with a high water content normally have a low mechanical stability, for example tear resistance. Polymers of silicones or fluorinated materials are, in contrast, highly hydrophobic and often have to be surface treated in order to be useable as contact lens material.

With the aim of avoiding the aforementioned disadvantages, further hydrogels have been proposed:

U.S. Pat. No. 5,352,714 discloses the copolymerization of a siloxane-containing methacrylic monomer, an oxazolone monomer and a further hydrophilic monomer. After the copolymerization, the oxazolone ring is converted by hydrolysis to the corresponding amino acid and by crosslinking to a hydrogel, which is used as a contact lens material.

In addition, EP-A-0374752 describes hydrogels formed from copolymers based on fluorinated monomers and saccharide monomers. In this case, a monomer mixture which contains a) 2-85 mol % of a hydrophobic fluorinated vinyl monomer, b) 2-80 mol % of a hydrophobic polyhydroxyvinyl monomer whose hydroxyl groups are present in protected form, c) 2-70 mol % of a hydrophilic vinyl monomer and d) 0-5 mol % of a crosslinker is polymerized, and the hydroxyl protecting groups are subsequently removed by acidic hydrolysis. The resulting hydrogels are advantageous with regard to the oxygen permeability and the water content.

Furthermore, U.S. Pat. No. 6,018,001 describes a process for producing contact lenses with a hydrophilic surface. In this case, a copolymer is first prepared from a glycerol ketal methacrylate and a siloxane-containing styrene monomer (hydrophobic). The copolymer may additionally also contain a hydrophilic monomer such as methacrylic acid and a crosslinking monomer such as ethylene glycol dimethacrylate. The hydrophobic contact lens material produced from this copolymer is subjected to an acid treatment for hydrophilisation, which converts the glycerol ketal methacrylate to the glyceryl monomethacrylate.

The materials known from the prior art are often, however, still in need of further improvement or too expensive from an economic point of view.

It is therefore an object of the invention to provide a hydrogel which has a high oxygen permeability, and also a good mechanical stability and good eye compatibility even in the case of prolonged wear.

The invention provides a hydrogel which is a copolymer formed from a polymerizable monomer mixture which contains
a) 10-65 mol % of at least one hydrophobic vinyl monomer of the formula I

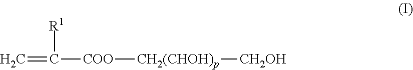

in which R¹ is hydrogen or methyl, p is an integer from 1 to 8, whose hydroxyl groups are present in protected form,
b) 25-70 mol % of at least one silicone-containing (meth)acrylate, vinyl carbonate or vinyl carbamate monomer,
c) 0-25 mol % of at least one hydrophilic vinyl monomer and
d) 0-10 mol % of at least one crosslinker, based on the total amount of monomers a) to c),
and where the hydroxyl groups of the segments formed by the monomers a) in the hydrogel are present in protected form or in free form.

The proportion of the hydrophobic vinyl monomer a) of the formula I in the monomer mixture is preferably 15-60 mol % and more preferably 20-40 mol %. It is important that the hydrophobic vinyl monomer a) is miscible with the silicone-containing monomer b).

In addition, in the formula I, p is preferably an integer from 1 to 4. The vinyl monomer a) of the formula I may be derived from sugar alcohols and encompasses all conceivable positional isomers. Examples of sugar alcohols from which compounds of the formula I are derived are xylitol, adonitol, arabitol, sorbitol, mannitol or dulcitol.

The hydroxyl groups of the compounds of the formula I which are present in protected form are protected by customary protecting groups, preferably in pairs as acid-labile ketals or especially orthoesters, for example as addition products with an optionally substituted ester or ketone. Two hydroxyl groups which are protected together as the ketal are, for example, protected together with a preferably substituted methylene group, such as by lower alkylidene, e.g. isopropylidene, cycloalkylidene, e.g. cyclohexylidene, or benzylidene.

The protected vinyl monomer a) is preferably a compound of the formula (Ia)

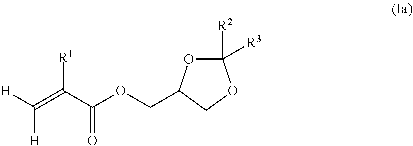

in which R¹ is hydrogen or methyl, R² is hydrogen or an optionally substituted C₁-C₆-alkyl or phenyl group, and R³ is an optionally substituted C₁-C₆-alkyl, C₁-C₆-alkoxy or phenyl group, or R² and R³ together form a C₅-C₈-cycloalkyl radical.
For R² and R³, independently, alkyl is preferably methyl or ethyl, alkoxy is preferably methoxy or ethoxy, and cycloalkyl is preferably cyclopentyl or cyclohexyl. Substituents include, by way of example, hydroxyl, amino, alkylamino, dialkylamino, halogen and/or alkylcarbonyl.

Preferably, in the formula (Ia), R² is methyl or ethyl and R³ is methyl, ethyl, methoxy or ethoxy, where R¹ is as defined above. More preferably, in the formula (Ia), R² is methyl or ethyl and R³ is methoxy or ethoxy.

The protected vinyl monomer a) is especially methyl (2-methoxy-2-methyl-1,3-dioxolan-4-yl)methacrylate (MMDMA), methyl (2-methoxy-2-methyl-1,3-dioxolan-4-yl)acrylate (MDMA) and/or 2,3-O-isopropylideneglyceryl methacrylate (IPGMA), most preferably MMDMA and/or MDMA.

The protected vinyl monomer a) is prepared generally by reacting an unsaturated carboxylic acid with a polyol or an epoxide derived therefrom (e.g. glycidol), and subsequently adding a hydroxyl protecting group. The preparation of unsaturated cyclic orthoesters is described, for example in EP-A-1714964.

The silicone-containing monomer b) is preferably a monomer of the formula (II) or (III)

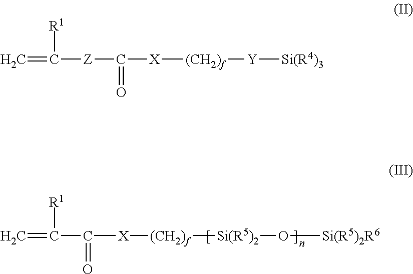

in which
X═O, NR¹ or 1,3-dioxopropan-2-ol,
Y═O or a bond,
Z═O or a bond,
R¹ is hydrogen or methyl,
R⁴ is independently C₁-C₄-alkyl or O—Si(R⁵)₃,
R⁵ is independently C₁-C₄-alkyl,
R⁶ is independently C₁-C₄-alkyl,
f is an integer from 1 to 10 and
n is an integer from 1 to 20.

Particular preference is given to silicone-containing monomers b) of the formula II in which f is an integer from 1 to 4, Z is a bond, X═O or 1,3-dioxopropan-2-ol, especially O, and R¹ and R⁴ are each methyl.

Likewise preferred are silicone-containing monomers b) of the formula III in which f is an integer from 1 to 4, X═O, and R¹ and R⁵ are each methyl.

Likewise preferred are silicone-containing monomers b) of the formula II in which Z═O, X═O or NR¹, R¹ is hydrogen, f is an integer from 2 to 4, and R⁴ is methyl.

The silicone-containing monomer b) is preferably selected from the group consisting of methacryloyloxypropyltris(trimethylsiloxy)silane (TRIS), methacryloyloxypropyl-bis(trimethylsiloxy)methylsilane, methacryloyloxypropylpentamethyldisiloxane, methacryloyloxymethylheptamethyltrisiloxane, methacryloyloxypropylpolydimethylsiloxane, methacryloyloxyethyltrimethylsiloxane, methyldi(trimethylsiloxy)silylpropylglycerol methacrylate and vinyloxycarbonylaminopropyltris(trimethylsiloxy)silane.

Very particular preference is given to methacryloyloxypropyltris(trimethylsiloxy)silane (TRIS).

The proportion of the silicone-containing (meth)acrylate, vinyl carbonate or vinyl carbamate monomer b) in the monomer mixture is preferably 30-65 mol % and more preferably 30-60 mol %.

The silicone-containing monomers b) used in accordance with the invention are prepared by methods known from the literature and some are also commercially available, for example TRIS, methacryloyloxypolydimethylsiloxane, tris(trimethylsiloxysilyl)propyl vinylcarbamate and acryloyloxymethyltrimethylsilane.

The hydrophilic vinyl monomer c) is selected from acrylates and methacrylates of the formula

H₂C═C(R¹)—COOR⁷,

in which R¹ is hydrogen or methyl and R⁷ is a C₁-C₁₀-alkyl radical which is mono- or polysubstituted by a water-solubilising group such as carboxyl, hydroxyl or tert-amino, a polyethylene oxide group having 2-100 repeating units or a sulphate, phosphate, sulphonate or phosphonate group,
and also acrylamides and methacrylamides of the formula

H₂C═C(R¹)—CON(R⁸)₂

in which R⁸ is hydrogen or C₁-C₄-alkyl and R¹ is as defined above;
acrylamides and methacrylamides of the formula

H₂C═C(R¹)—CONHR⁸

in which R¹ and R⁸ are each as defined above;
maleates and fumarates of the formula

R⁷OOC—CH═CH—COOR⁷;

Crotonates of the formula CH₃—CH═CH—COOR⁷;
vinyl ethers of the formula H₂C═CH—OR⁷;
in which R⁷ is in each case as defined above,
vinyl-substituted five- or six-membered heterocycles having one or two nitrogen atoms, especially N-vinyllactams having 4-6 carbon atoms, and vinylically unsaturated carboxylic acids having a total of 3-10 carbon atoms, such as methacrylic acid, crotonic acid, fumaric acid or cinnamic acid.

The vinyl monomer c) is preferably selected from hydroxyl-, carboxyl- or tert-amino-substituted C₁-C₆-alkyl(meth)acrylates, hydroxyl- or carboxyl-substituted C₁-C₄-alkyl(meth)acrylamides, hydroxy(meth)acrylamide silyl ethers, (meth)acrylamides, five- to seven-membered N-vinyllactams, N,N-di-C₁-C₄-alkyl(meth)acrylamides, vinylically unsaturated carboxylic acids having 3 to 5 carbon atoms, vinyl carbonates, vinyl carbamates, N-vinyl-N-C₁-C₄-alkylacetamides, di-, tri-, polyethylene glycol methacrylates and glyceryl methacrylates.

Especially preferred are hydroxyl-substituted C₂-C₄-alkyl(meth)acrylates, five- to seven-membered N-vinyllactams, N,N-di-C₁-C₄-alkyl(meth)acrylamides and vinylically unsaturated carboxylic acids having 3 to 5 carbon atoms.

Examples of water-soluble monomers c) include: 2-hydroxyethyl, 2- and 3-hydroxypropyl, 2,3-dihydroxypropyl, polyethoxyethyl and polyethoxypropyl acrylates and methacrylates, and the corresponding acrylamides and methacrylamides, acrylamide and methacrylamide, N-methylacrylamide and -methacrylamide, bisacetoneacrylamide, 2-hydroxyethyl-acrylamide, dimethylacrylamide and -methacrylamide, and methylolacrylamide and -methacrylamide, N,N-dimethyl- and N,N-diethylaminoethyl acrylate and methacrylate, and the corresponding acrylamides and methacrylamides, N-tert-butylaminoethyl methacrylate and N-tert-butylaminoethylmethacrylamide, 2- and 4-vinylpyridine, 4- and 2-methyl-5-vinylpyridine, N-methyl-4-vinylpiperidine, 1-vinyl- and 2-methyl-1-vinylimidazole, dimethylallylamine and methyldiallylamine, and para- and ortho-aminostyrene, dimethylaminoethyl vinyl ether, N-vinylpyrrolidone and 2-pyrrolidinoethyl methacrylate, acrylic and methacrylic acid, itaconic acid, cinnamic acid, crotonic acid, fumaric acid, maleic acid and the hydroxy(lower alkyl) mono- and diesters thereof, such as 2-hydroxyethyl and di(2-hydroxy)ethyl fumarate, maleate and itaconate, and 3-hydroxypropyl butylfumarate and di(polyalkoxyalkyl) fumarates, maleates and itaconates, maleic anhydride, sodium acrylate and methacrylate, 2-methacryloyloxyethylsulphonic acid, 2-acrylamido-2-methylpropanesulphonic acid, 2-phosphatoethyl methacrylate, vinylsulphonic acid, sodium vinylsulphonate, p-styrenesulphonic acid, sodium p-styrenesulphonate and allylsulphonic acid, N-vinylpyrrolidone, N-vinylcaprolactam, and also the quaternised derivatives of cationic monomers which are obtained by quaternisation with selected alkylating agents, for example halogenated hydrocarbons such as methyl iodide, benzyl chloride or hexadecyl chloride, epoxides such as glycidol, epichlorohydrin or ethylene oxide, acrylic acid, dimethyl sulphate, methyl sulphate and propane sulphone.

A more complete list of water-soluble monomers c) which can be used for this invention can be found in: R. H. Yocum and E. B. Nyquist, Functional Monomers, Volume 1, p. 424-440 (M. Dekker, N.Y. 1973).

Very particularly preferred monomers c) are 2-hydroxyethyl methacrylate, N-vinyl-2-pyrrolidone, N,N-dimethylacrylamide and acrylic and/or methacrylic acid, especially 2-hydroxyethyl methacrylate and/or methacrylic acid.

The proportion of the vinyl monomer c) in the monomer mixture is preferably 5-20 mol % and more preferably 10-15 mol %.

The crosslinkers d) used are especially diolefinic monomers, for example allyl acrylate and methacrylate, diacrylates and dimethacrylates of ethylene glycol, of diethylene glycol, of triethylene glycol, of tetraethylene glycol and generally of polyethylene oxide glycol, diacrylates and dimethacrylates of 1,4-butanediol and of poly-n-butylene oxide glycol, diacrylates and dimethacrylates of propylene glycol and polypropylene oxide glycol, thiodiethylene glycol diacrylate and dimethacrylate, di(2-hydroxyethyl)sulphone diacrylate and dimethacrylate, neopentyl glycol diacrylate and dimethacrylate, trimethylolpropane tri- and tetraacrylate, pentaerythrityl tri- and tetraacrylate, divinylbenzene, divinyl ether, divinyl sulphone, disiloxanyl bis(3-hydroxypropyl)diacrylate or dimethacrylate, and related compounds.

Ethylene glycol dimethacrylate is preferred.

The crosslinker is, if present, preferably used in amounts of 1.0 to 3.0 mol %, especially 1.4-1.7 mol %, based in each case on the total amount of monomers a) to c).

The inventive hydrogels are obtained by free-radical copolymerization, either in bulk or in the presence of customary solvents. In a particular embodiment, polymerization in the presence of an alcohol, for example amyl alcohol, has been found to be advantageous for the swelling behaviour. The polymerization is appropriately performed under hot conditions, preferably in the presence of an initiator which forms free radicals, for example at a temperature in the range from about 30° C. to about 105° C. The initiators used are preferably peroxides or azo catalysts. Typical examples of useable peroxy compounds are isopropyl percarbonate, tert-butyl peroctoate, benzoyl peroxide, lauroyl peroxide, decanoyl peroxide, acetyl peroxide, succinyl peroxide, methyl ethyl ketone peroxide, tert-butyl peroxyacetate, propionyl peroxide, 2,4-dichlorobenzoyl peroxide, tert-butyl peroxypivalate, tert-butyl peroxy-2-ethylhexanoate, pelargonyl peroxide, 2,5-dimethyl-2,5-bis(2-ethylhexanoylperoxy)hexane, p-chlorobenzoyl peroxide, tert-butyl peroxybutyrate, tert-butylperoxymaleic acid, tert-butyl peroxyisopropylcarbonate and bis(1-hydroxycyclohexyl)peroxide.

Suitable azo compounds are 2,2-azobisisobutyronitrile, 2,2′-azobis(2,4-dimethylvaleronitrile), 1,1-azobis(cyclohexanecarbonitrile) and 2,2-azobis(2,4-dimethyl-4-methoxyvaleronitrile).

The amount of initiator may vary between 0.002 and 1 mol %, based on constituents a) to d), but is preferably 0.03 to 0.3 mol %.

To initiate the polymerization, it is also possible to employ other mechanisms for forming free radicals, such as radiation, for example X-radiation, electron beams, γ or UV radiation.

The monomers a) to c) used and the crosslinker d) are known, and some are commercially available or preparable by processes known per se. They are appropriately purified before the polymerization, especially in order to remove inhibitors with which they are stabilised. The polymerization mixtures are then polymerized in a manner known per se.

In order to obtain the inventive hydrogel, the copolymers obtainable as described above have to be hydrated. This is appropriately done by storing in aqueous buffered sodium chloride solution which is preferably isotonic. Before the hydration, the polymers are optionally cut into thin slices or polymerized directly in a form which is suitable for production of contact lenses.

The copolymers obtainable as described above still contain, in the segments formed by the vinyl monomers a), the hydroxyl groups present there in protected form. They are therefore still comparatively highly hydrophobic. By elimination of the protecting groups and subsequent hydration, it is possible to convert them to the inventive hydrogel which contains, in the segments formed by the vinyl monomers a), the hydroxyl groups present there in free form.

The protecting groups can be eliminated by introduction into an acidic medium, for example into dilute HCl or acetic acid, as is commonly known from the technical literature (Beyer, Walter: Lehrbuch der Organischen Chemie [Textbook of Organic Chemistry], S. Hirzel-Verlag Stuttgart, including the chapter “Reaktionen der Aldehyde” [Reactions of the Aldehydes]). The elimination of protecting groups hydrophilises the segments formed by the vinyl monomers a). This allows the ability of the copolymer formed to absorb water to be enhanced significantly. In this way, it is possible by means of hydration to prepare a both highly oxygen-permeable and hydrophilic hydrogel.

The process according to the invention enables preparation of copolymers composed of hydrophilic and hydrophobic sequence units which, both in the unswollen state and in the swollen state (hydrogel), do not have any phase separation and are thus visually clear.

The inventive hydrogels have very good oxygen permeabilities and at the same time are hydrophilic and additionally mechanically stable, i.e. they have, for example, a high tear strength. They are therefore outstandingly suitable as materials for contact lenses or intraocular lenses and as other biocompatible materials, for example implants, blindfolds, transdermal systems or other forms of medicament carriers.

Contact lenses can be produced from said hydrogels in a manner known per se. To this end, the mixtures to be polymerized are polymerized, for example in cylindrical form, and the resulting rods, after demoulding, are cut into slices or buttons, which can be processed further mechanically. Alternatively, the polymerization can also be carried out in lens moulds, such that lens blanks are obtained directly as polymers.

The examples which follow illustrate the subject matter of the invention, but without restricting it, for instance to the scope of the examples.

### EXAMPLES

The polymerizations were carried out at 80° C. in bulk for 2 h (Examples 1-9, 12+13) as random copolymerizations, using tert-butyl peroxy-2-ethylhexanoate (V 69) as the initiator. In Examples 10 and 11, polymerization was effected analogously, but in the presence of amyl alcohol (monomer/amyl alcohol=60:40 (v:v)).

The silicone-containing monomer b) used was methacryloyloxypropyltris-(trimethylsiloxy)silane (TRIS); the vinyl monomer a) used was methyl (2-methoxy-2-methyl-1,3-dioxolan-4-yl)methacrylate (MMDMA), methyl (2-methoxy-2-methyl-1,3-dioxolan-4-yl)acrylate (MDMA) or 2,3-O-isopropylideneglyceryl methacrylate (IPGMA).

The crosslinker d) used was ethylene glycol dimethacrylate (EGDMA) and, optionally, an additional hydrophilic monomer c) used was hydroxyethyl methacrylate (HEMA) and/or methacrylic acid (MAA).

TABLE 1
Monomer mixtures

| | | | | | | | | Initiator | |
|---|---|---|---|---|---|---|---|---|---|
| | | | | | | | | % by | Swelling |
| | Monomer mixture (% by weight) | | | | | | | wt. | after 96 h |
| Example | IPGMA | TRIS | MMDA | MMDMA | EGDMA | HEMA | MAA | V69 | [%] |
| 1 | 8.5 | 81.9 | — | — | 1 | 8.6 | — | 0.1 | 1.83 |
| 2 | 17 | 73.9 | — | — | 0.5 | 8.6 | — | 0.1 | 1.59 |
| 3 | 22.5 | 77 | — | — | 0.5 | — | — | 0.1 | 2.87 |
| 4 | 17.25 | 73.9 | — | — | 0.25 | 8.6 | — | 0.1 | 1.05 |
| 5 | 22.75 | 77 | — | — | 0.25 | — | — | 0.1 | 0.98 |
| 6 | — | 73.9 | — | 17 | 0.5 | 8.6 | — | 0.1 | 2.89 |
| 7 | — | 77 | — | 22.5 | 0.5 | — | — | 0.1 | 2.15 |
| 8 | — | 73.9 | — | 17.25 | 0.25 | 8.6 | — | 0.1 | 2.90 |
| 9 | — | 77 | — | 22.75 | 0.25 | — | — | 0.1 | 2.24 |
| 10* | — | 73.9 | — | 17 | 0.5 | — | — | 0.1 | 12.39 |
| 11* | — | 73.9 | — | 17 | 0.5 | — | — | 0.1 | 10.66 |
| 12 | — | 81.9 | 8.5 | — | 1 | 4.3 | 4.3 | 0.1 | 1.02 |
| 13 | — | 81.9 | 8.5 | — | 1 | 8.6 | — | 0.1 | 2.59 |

*Polymerization in the presence of amyl alcohol in a monomer/amyl alcohol ratio = 60/40 (v:v); after polymerization, the resulting polymers were cut into slices and extracted three times with 70/30 (v:v) isopropanol/water, then placed into deionised water, and the swelling tests were carried out as before on the other polymer samples

After the polymerization, transparent rod-shaped copolymers were obtained in all cases, which were cut into slices of thickness 4 mm for further characterization. To deketalise the dioxolane ring of the M(M)DMA units or MDMA units present therein, the copolymers were subjected to an acid treatment. To this end, hydrolysis with 3 M HCl at 70° C. for 2½ h was followed by neutralisation for 1 h. A 3% Na₂CO₃ solution was used for the neutralisation.

The hydrolysed copolymers were subjected to swelling tests in tear replacement fluid similar to DIN EN ISO 18369-4. The tear replacement fluid consisted of 0.9% NaCl solution which is adjusted to a pH of 7.3 with buffer solution. The polymers maintained their transparent character in the tear replacement fluid too.

$$Swelling ( \% ) = \frac{\begin{matrix}weight after 96 h in fluid - \\ weight after drying at 50 ° C . for 24 hours\end{matrix}}{weight after drying at 50 ° C . for 24 hours} \times 100$$

The copolymers have excellent hydrophilic properties and can therefore be used as mechanically robust contact lens materials with high oxygen permeability and good eye compatibility.

1. A hydrogel which is a copolymer formed from a polymerizable monomer mixture which comprises
a) 10-65 mol % of at least one hydrophobic vinyl monomer of the formula I 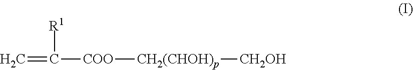
in which R¹ is hydrogen or methyl, p is an integer from 1 to 8, whose hydroxyl groups are present in protected form,
b) 25-70 mol % of at least one (meth)acrylate, vinyl carbonate or vinyl carbamate silicone monomer,
c) 0-25 mol % of at least one hydrophilic vinyl monomer and
d) 0-10 mol % of at least one crosslinker, based on the total amount of monomers a) to c),
and where the hydroxyl groups of the segments formed by the monomers a) in the hydrogel are present in protected form or in free form.

2. The hydrogel according to claim 1, wherein p in the vinyl monomer a) is an integer from 1 to 3.

3. The hydrogel according to claim 1, wherein the protected vinyl monomer a) is a compound of the formula (Ia) 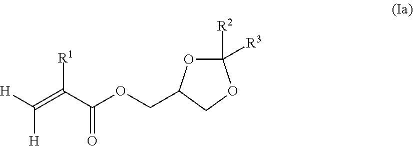
in which R¹ is hydrogen or methyl, R² is hydrogen, an optionally substituted C₁-C₆-alkyl or phenyl group, and R³ is an optionally substituted C₁-C₆-alkyl, C₁-C₆-alkoxy or phenyl group, or R² and R³ together form a C₅-C₈-cycloalkyl radical.

4. The hydrogel according to claim 1, wherein the silicone monomer b) is a monomer of the formula (II) or (III) 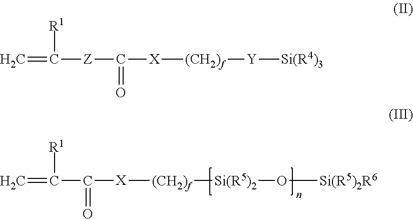
in which
X═O, NR¹ or 1,3-dioxopropan-2-ol,
Y═O or a bond,
Z═O or a bond,
R¹ is hydrogen or methyl,
R⁴ is independently C₁-C₄-alkyl or O—Si(R⁵)₃,
R⁵ is independently C₁-C₄-alkyl,
R⁶ is independently C₁-C₄-alkyl,
f is an integer from 1 to 10 and
n is an integer from 1 to 20.

5. The hydrogel according to claim 4, wherein, in the monomer of the formula (II),
f is an integer from 1 to 4, Z is a bond, X═O or 1,3-dioxopropan-2-ol, especially O, and R¹ and R⁴ are each methyl.

6. The hydrogel according to claim 4, wherein, in the monomer of the formula (II),
Z═O, X═O or NR¹, R¹ is hydrogen, f is an integer from 2 to 4, and R⁴ is methyl.

7. The hydrogel according to claim 1, wherein b) is a polysiloxanylalkyl(meth)acrylate monomer selected from the group consisting of methacryloyloxypropyltris(trimethylsiloxy)silane, methacryloyloxypropyl-bis(trimethylsiloxy)methylsilane, methacryloyloxypropylpentamethyldisiloxane, methacryloyloxymethylheptamethyltrisiloxane, methacryloyloxypropylpolydimethylsiloxane, methacryloyloxyethyltrimethylsiloxane, methyldi(trimethylsiloxy)silylpropylglycerol methacrylate and vinyloxycarbonylaminopropyltris(trimethylsiloxy)silane.

8. The hydrogel according to claim 1, wherein the vinyl monomer c) is selected from the group consisting of a hydroxyl-substituted C₁-C₆-alkyl(meth)acrylate, a carboxyl-substituted C₁-C₆-alkyl(meth)acrylate, a tert-amino-substituted C₁-C₆-alkyl(meth)acrylate, a hydroxyl-substituted C₁-C₄-alkyl(meth)acrylamide, a carboxyl-substituted C₁-C₄-alkyl(meth)acrylamide, a hydroxy(meth)acrylamide silyl ether, a (meth)acrylamide, a five- to seven-membered N-vinyllactam, an N,N-di-C₁-C₄-alkyl(meth)acrylamide, a vinylically unsaturated carboxylic acid having 3 to 5 carbon atoms, a vinyl carbonate, a vinyl carbamate, an N-vinyl-N-C₁-C₄-alkylacetamide, a diethylene glycol methacrylate, a triethylene glycol methacrylate, a polyethylene glycol methacrylate and a glyceryl methacrylate.

9. The hydrogel according to claim 1, wherein the vinyl monomer c) is selected from the group consisting of 2-hydroxyethyl methacrylate, N-vinyl-2-pyrrolidone, N,N-dimethylacrylamide, acrylic acid and methacrylic acid.

10. The hydrogel according to claim 1, wherein the vinyl monomer a) is methyl (2-methoxy-2-methyl-1,3-dioxolan-4-yl)methacrylate and/or methyl (2-methoxy-2-methyl-1,3-dioxolan-4-yl)acrylate, the vinyl monomer b) is methacryloyloxypropyltris(trimethylsiloxy)silane and the vinyl monomer c) is 2-hydroxyethyl methacrylate and/or methacrylic acid.

11. The hydrogel according to claim 1, wherein the hydroxyl groups of the segments formed by the monomers a) are present in free form.

12. A process for preparing a The hydrogel according to claim 11 comprising free-radical polymerizing and acidic hydrolyzing the hydroxyl protecting groups.

13. (canceled)

14. A contact lens or intraocular lens comprising the hydrogel according to claim 11.
